(19) United States
(12) Patent Application Publication
(10) Pub. No.: US 2018/0285978 A1
(43) Pub. Date: Oct. 4, 2018

(54) Systems and Methods for Use in Providing Indicators Related to Insurance Products, Based on Transaction Data

(71) Applicant: MASTERCARD INTERNATIONAL INCORPORATED, Purchase, NY (US)

(72) Inventors: Peter Groarke, Dublin (IE); Ahmed Hosny, Dublin (IE)

(21) Appl. No.: 15/476,473

(22) Filed: Mar. 31, 2017

(51) Int. Cl. G06Q 40/08; G06Q 20/10

(52) U.S. Cl. CPC G06Q 40/08; G06Q 20/10

(57) ABSTRACT

Systems and methods are provided for use in determining at least one insurance indicator related to an insurance product of interest based on transaction data for various merchants. One exemplary method includes receiving, from a requestor, a request for an insurance indicator associated with an insurance product of interest in a region and retrieving, by a computing device, a plurality of transactions, each transaction involving a purchase of the issuance product of interest and being associated with the region. The method also includes aggregating, by the computing device, the plurality of transactions to define the insurance indicator where the insurance indicator is indicative of at least one premium for the insurance product of interest, and transmitting the insurance indicator to the requestor, such that the requestor is informed about cost of the insurance product of interest in the region.

### FIELD

The present disclosure generally relates to systems and methods for use in providing indicators related to insurance products of interest based on transaction data, and more particularly, to systems and methods for use in aggregating transaction data in particular regions in order to provide such indicators for the insurance products of interest (e.g., based on price, etc.).

### BACKGROUND

This section provides background information related to the present disclosure which is not necessarily prior art.

Payment accounts are used by consumers to purchase a variety of products, including, for example, goods and services. Insurance products, for example, are products also known to be purchased through payment accounts, often at one or more regular intervals, and through insurance brokers who provide different quotes/rates for different insurance products offered by different insurance providers. When an insurance product is selected, a consumer is able to purchase the insurance product from the insurance broker and/or the corresponding insurance provider (broadly, from an insurance merchant) and fund the purchase, often in the form of one or more premiums, with a payment account associated with the consumer.

Separately, when products, in general, are purchased by consumers using payment accounts, transaction data relating to the purchases is known to be gathered and stored by issuers of the payment accounts and/or payment networks involved in processing the purchases. In turn, the transaction data may then be used, for example, to modify and/or improve services offered by the issuers and/or payment networks including, for example, fraud detection services, etc., or to predict future purchases of products by the consumers (e.g., based on the consumers' prior purchases of the same products, related products, etc.). It is also known for the transaction data to include certain category information such as that defined by merchant category codes (MCCs), etc., which enables the issuers and/or the payment networks to categorize the purchases (broadly, the transactions associated with the purchases) when processing the transaction data.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in aggregating transaction data for insurance products purchased through payment accounts, in particular regions, to provide one or more indicators related to insurance products of interest (e.g., related to price, etc.);

FIG. 2 is a block diagram of a computing device that may be used in the exemplary system of FIG. 1; and

FIG. 3 is an exemplary method, which may be implemented in connection with the system of FIG. 1, for aggregating transaction data for insurance products, in particular regions, to provide the one or more indicators related to the insurance products of interest.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Insurance products are purchased by consumers from insurance merchants to protect assets associated with the consumers, including assets such as, for example, homes (broadly, premises), automobiles, etc., in case of accidents, natural disasters, etc. (broadly, loss events). In connection therewith, the insurance merchants charge premiums for the insurance products based on, for example, the types of the insurance products (e.g., homeowner's insurance versus automobile insurance, etc.) and the coverages defined by the insurance products (e.g., $100,000 versus $250,000, etc.). Uniquely, the systems and methods herein provide one or more insurance indicators for insurance products within a region based on prior transactions for the insurance products (and/or similar insurance products). In particular, for example, an insurance engine compiles transaction data for transactions that involve insurance merchants, and also identifies types of insurance products involved in the transactions and corresponding locations of the transactions and/or insurance products (e.g., as defined by transaction requests for the insurance products, etc.). Then, in response to a particular request by a consumer interested in purchasing a particular insurance product in a given region, the insurance engine generates one or more insurance indicators for the particular insurance product of interest based on the aggregated transaction data. The insurance indicators may include, for example, a highest premium, a lowest premium, and/or an average premium, within the given region, for the particular insurance product included in the consumer's request. In so doing, the consumer is efficiently provided one or more indicators of what he/she should be paying for insurance for the particular insurance product of interest, as informed by what others in the region are paying.

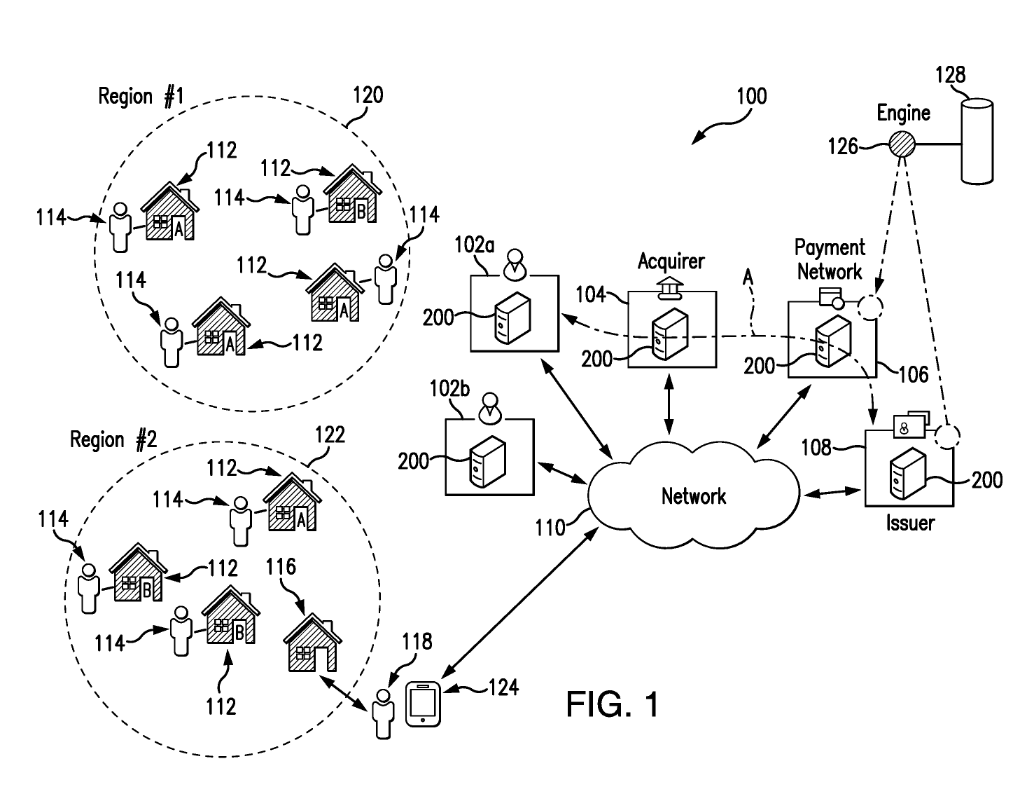

FIG. 1 illustrates an exemplary system 100, in which the one or more aspects of the present disclosure may be implemented. Although the system 100 is presented in one arrangement, other embodiments may include the parts of the system 100 (or other parts) arranged otherwise depending on, for example, number and/or type of insurance merchants included in the system 100, etc.

As shown in FIG. 1, the system 100 generally includes two insurance merchants 102a and 102b, an acquirer 104 associated with the insurance merchants 102a and 102b, a payment network 106, and an issuer 108 configured to issue payment accounts to consumers, each of which is coupled to (and is in communication with) network 110. The network 110 may include, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. For example, network 110 may include multiple different networks, such as a private payment transaction network made accessible by the payment network 106 to the acquirer 104 and the issuer 108 and, separately, the public Internet, which may provide interconnection between the merchants 102a and 102b, the payment network 106, and other parts of the system 100.

The insurance merchants 102a and 102b in the system 100 are each generally associated with one or more insurance products such as, for example, homeowners insurance, automobile insurance, renters insurance, or other types of insurance products as desired, etc. Generally, in this embodiment, the insurance merchants 102a and 102b offer for sale and sell insurance products that cover homes, i.e., homeowners insurance and/or renters insurance products. As such, each of the merchants 102a and 102b is associated with a particular merchant category code (MCC) associated with insurance, for example, MCC 6300 for “Insurance Sales, Underwriting, and Premiums.” The use of this particular MCC, and others, is described in more detail below.

The system 100 also includes multiple premises, each indicated at 112. The premises 112 may include, for example, residential homes, or other types of structures, buildings, business, and/or domiciles (e.g., apartments, etc.) for one or more persons. Particular profiles of the premises 112 (e.g., number of bedrooms, number of bathrooms, size (e.g., square footage, etc.), number of stories, construction type, etc.) are described in further detail below. In addition, each of the premises 112 is associated with a consumer 114, who is generally the owner or other responsible person (or entity) (e.g., landlord, manager, caretaker, custodian, etc.) of the premises 112. Each consumer 114 is associated with a payment account issued by the issuer 108, which in this embodiment is used by the respective consumer 114 to purchase homeowners insurance for the respective premises 112. In this example, the premises 112 marked with an “A” in FIG. 1 are covered by an insurance product purchased from the insurance merchant 102a, and the premises 112 marked with a “B” are covered by an insurance product from the insurance merchant 102b.

In an example transaction between one of the consumers 114 and the insurance merchant 102a for homeowners insurance for his/her premises 112, the consumer 114 provides credentials associated with his/her payment account to the insurance merchant 102a in order to pay a premium for a term of the homeowners insurance (e.g., for coverage for one year, etc.). In turn, the merchant 102a compiles an authorization request for the transaction and transmits the authorization request to the acquirer 104, along path A in FIG. 1. The authorization request includes, for example, a primary account number (PAN) for the consumer's payment account, an expiration date for the payment account and/or payment device used in the transaction, an amount of the premium, a merchant ID (associated with the merchant 102a), a merchant address, a country code for the merchant 102a, a terminal ID, an MCC associated with the merchant 102a (and/or the homeowners insurance product), a date/time of the transaction, an acquirer ID for the acquirer 104, etc. In response, the acquirer 104 communicates the authorization request to the issuer 108, through the payment network 106 (e.g., through MasterCard®, VISA®, Discover®, American Express®, etc.) (again along path A in FIG. 1), to determine whether the payment account is in good standing and whether there is sufficient credit or funds to complete the transaction. If the issuer 108 accepts/approves the transaction, the issuer 108 transmits an authorization reply indicating the approval back to the acquirer 104 and the merchant 102a, thereby permitting the merchant 102a to continue in the transaction. The transaction is later cleared and/or settled by and between the merchant 102a and the acquirer 104, and by and between the acquirer 104 and the issuer 108 (via appropriate agreements). If the issuer 108 declines the transaction, however, the issuer 108 transmits an authorization reply indicating the decline back to the acquirer 104 and the merchant 102a, thereby permitting the merchant 102a to halt the transaction (or seek alternate funding).

It should be appreciated that transactions for insurance products between the insurance merchant 102a and other ones of the consumers 114 would proceed in substantially the same manner as the exemplary transaction described above. Similarly, transactions for insurance products between the insurance merchant 102b and one or more of the consumers 114 would also proceed in substantially the same manner as described above. As a result, one or more prior transactions for insurance products will exist for each of the premises 112 labeled “A” and “B” in FIG. 1 and/or for each of the premiums paid by the consumers 114 to the respective insurance merchants 102a or 102b for the insurance products purchased for the premises 112.

Transaction data is generated, collected, and stored as part of the above interactions among the insurance merchant 102a, the acquirer 104, the payment network 106, and/or the issuer 108, etc. The transaction data, in this exemplary embodiment, is stored in one or more data structures (e.g., data structure 128 described below, etc.). With that said, transaction data may include, for example, payment account numbers, amounts of transactions, merchant IDs, merchant names, MCCs, merchant addresses, country codes, transaction amounts, acquirer ID, dates/times of transactions, products purchased and related descriptions or identifiers, etc. It should be appreciated that more or less information related to transactions, as part of either authentication of consumers, authorization and/or clearing and/or settling of transactions, etc., may be included in transaction data and stored within the system 100, again, in one or more data structures, etc.

In various exemplary embodiments, consumers 114 (and consumer 118 described below) involved in the different transactions herein are prompted to agree to legal terms associated with their payment accounts, for example, during enrollment in their accounts, etc. In so doing, the consumers may voluntarily agree, for example, to allow issuers of the payment accounts, payment networks, or other entities, etc., to use data collected during enrollment and/or collected in connection with processing transactions to the payment accounts, subsequently, for one or more of the different purposes described herein.

With continued reference to FIG. 1, the system 100 further includes a premises 116 associated with and/or owned by consumer 118. The premises 116, like the premises 112 described above, may include, for example, a residential home, or another type of structure (or structures), building(s), business (or businesses), and/or domicile(s) for one or more persons. The particular profile of the premises 116 (e.g., number of bedrooms, number of bathrooms, size (e.g., square footage, etc.), number of stories, construction type, etc.) is described in further detail below. In this exemplary embodiment, the premises 116 either is not yet covered by an insurance product from either the insurance merchant 102a or the insurance merchant 102b, and/or current coverage of the premises 116 by an insurance product is about to lapse. As such, in the following examples herein, the consumer 118 is described as using the various features herein in connection with obtaining one or more insurance products for the premises 116.

As shown in FIG. 1, the premises 112 and 116 are segregated into two regions 120 and 122. The regions 120 and 122 may each be defined by any type of geographic or other boundary, such as, for example, area code, zip code, city, town, county, district, province, municipality, state, territory, country, etc. In one example, the region 120 may be defined by one postal code while the region 122 may be defined by another postal code.

In addition in the system 100, the consumer 118 is associated with a payment account issued by the issuer 108, which can be used by the consumer 114 to perform purchase transactions as described herein, for example, for insurance products from one or both of the insurance merchants 102a and 102b, etc. Further still, the system 100 includes a communication device 124 associated with the consumer 118. The communication device 124 may include, for example, a personal computer, a tablet, a smartphone, etc., which is configured to operate as described herein.

While only two insurance merchants 102a and 102b, one acquirer 104, one payment network 106, and one issuer 108 are illustrated in FIG. 1, it should be appreciated that any number of these entities (and their associated components) may be included in the system 100, or may be included as parts of systems in other embodiments, consistent with the present disclosure. Likewise, it should be appreciated that a different number of premises, regions, consumers, and communication devices may be included in the system, or as parts of systems in other embodiments.

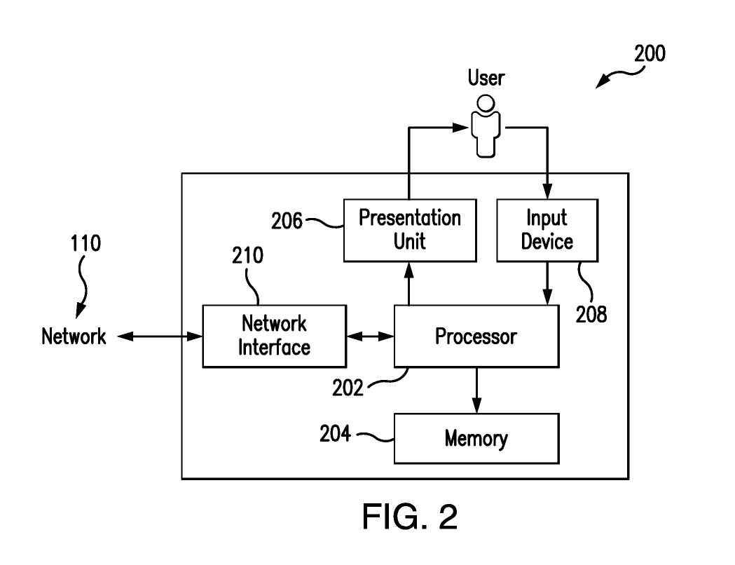

FIG. 2 illustrates an exemplary computing device 200 that can be used in the system 100. The computing device 200 may include, for example, one or more servers, workstations, personal computers, laptops, tablets, smartphones, PDAs, etc. In addition, the computing device 200 may include a single computing device, or it may include multiple computing devices located in close proximity or distributed over a geographic region, so long as the computing devices are configured to function as described herein. In the exemplary embodiment of FIG. 1, each of the insurance merchants 102a and 102b, the acquirer 104, the payment network 106, and the issuer 108 are illustrated as including, or being implemented in, computing device 200, coupled to the network 110. In addition, the communication device 124 may be considered a computing device consistent with the computing device 200. However, the system 100 should not be considered to be limited to the computing device 200, as described below, as different computing devices and/or arrangements of computing devices may be used.

Referring to FIG. 2, the exemplary computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the operations described herein.

The memory 204, as described herein, is one or more devices that permit data, instructions, etc. to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, data relating to insurance products, payment account numbers (e.g., PANS, etc.), amounts of transactions, merchant IDs, acquirer IDs, merchant names, MCCs, merchant addresses, country codes (or other location codes), dates/times of transactions, and/or other types of data (and/or data structures) suitable for use as described herein. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. Such instructions often improve the efficiencies and/or performance of the processor 202 that is performing one or more of the various operations herein.

In the exemplary embodiment, the computing device 200 also includes a presentation unit 206 that is coupled to (and that is in communication with) the processor 202 (however, it should be appreciated that the computing device 200 could include output devices other than the presentation unit 206, etc.). The presentation unit 206 outputs information, such as, for example, insurance indicator(s), etc., visually to a user of the computing device 200, such as one of the consumers 114 and 118; etc. It should be appreciated that various interfaces (e.g., as defined by network-based applications (including websites), etc.) (broadly, network-based interfaces) may be displayed at computing device 200, and in particular at presentation unit 206, to display such information. The presentation unit 206 may include, without limitation, a liquid crystal display (LCD), a light-emitting diode (LED) display, an organic LED (OLED) display, an “electronic ink” display, speakers, etc. In some embodiments, presentation unit 206 includes multiple devices.

In addition, the computing device 200 includes an input device 208 that receives inputs from the user (i.e., user inputs) such as, for example, a selection of an insurance product and/or insurance merchant, etc. The input device 208 may include a single input device or multiple input devices. The input device 208 is coupled to (and is in communication with) the processor 202 and may include, for example, one or more of a keyboard, a pointing device, a mouse, a stylus, a touch sensitive panel (e.g., a touch pad or a touch screen, etc.), another computing device, and/or an audio input device. Further, in various exemplary embodiments, a touch screen, such as that included in a tablet, a smartphone, or similar device, behaves as both a presentation unit and an input device.

Further, the illustrated computing device 200 also includes a network interface 210 coupled to (and in communication with) the processor 202 and the memory 204. The network interface 210 may include, without limitation, a wired network adapter, a wireless network adapter, a mobile network adapter, or other device capable of communicating to one or more different networks, including the network 110. Further, in some exemplary embodiments, the computing device 200 includes the processor 202 and one or more network interfaces incorporated into or with the processor 202.

Referring again to FIG. 1, the system 100 includes an insurance engine 126 and data structure 128. The insurance engine 126 is configured, by executable instructions, to operate as described herein. As shown, the insurance engine 126 is a standalone device, such as, for example, a computing device consistent with the computing device 200, generally in communication with the payment network 106 and/or the issuer 108. However, it should be appreciated that the insurance engine 126 may be integrated in whole or in part with the payment network 106 and/or the issuer 108, as indicated by the dotted lines. The data structure 128 is coupled to and is in communication with the insurance engine 126. While the data structure 128 is illustrated as separate from the insurance engine 126, it should be appreciated that the data structure 128 may be incorporated with the insurance engine 126, for example, in memory 204 therein, etc. And, when the insurance engine 126 is incorporated into the payment network 106 and/or the issuer 108 (or otherwise), the data structure 128 will be also incorporated therewith.

The data structure 128 is configured to store a variety of transaction data (e.g., as populated in conjunction with the payment network 106, the issuer 108, etc.), which is used herein, by the insurance engine 126, to provide insurance indicators for certain insurance products and/or for certain regions (as will be described more hereinafter). For example, the data structure 128 may include, without limitation, transaction data for various merchants, including the insurance merchants 102a and 102b and other merchants. And, as described above, the transaction data may include, without limitation, payment account numbers, amounts of transactions, merchant names, merchant IDs, MCCs, merchant addresses, country codes, dates/times of transactions, etc.

In this exemplary embodiment, the insurance engine 126 is configured to identify insurance merchants, in the data structure 128 (based on their association with the transaction data in the data structure 128), as associated with and/or as providing a certain type of insurance product, such as, for example, homeowners insurance. In particular, for example, the insurance engine 126 may be configured to initially identify insurance merchants in the data structure 128 that are property insurance providers, for example, by merchant name, by merchant ID, by acquirer ID, by MCC, etc. In the system 100, insurance merchant 102a may be named “ABC Insurance Company” and may offer to sell, and sell, homeowners insurance and automobile insurance, and may also provide different banking products (e.g., checking accounts, savings accounts, etc.). As such, in connection with identifying insurance merchants in the data structure 128 that are property insurance providers, the insurance engine 126 may identify the merchant 102a in the data structure 128 (as one of such merchants) as follows. For example, the insurance engine 126 may be configured to perform a name search for “insurance” in the transaction data in the data structure 128 (which would identify insurance merchant 102a, as well as other insurance merchants), and to filter the results based on the MCC specific to insurance products (i.e., MCC 6300, etc.) (e.g., to distinguish potential merchants that have “insurance” in their name but don't sell insurance products, etc.). Further, because the insurance merchant 102a sells multiple types of insurance, the insurance engine 126 may further be configured to filter the results based on merchant ID, since the merchant 102a will typically have one merchant ID specific to homeowners insurance, and a different merchant ID associated with automobile insurance (e.g., to distinguish insurance merchants that don't sell homeowners insurance from ones that do, etc.). As such, by filtering the initial “insurance” merchants by MCC and merchant ID, the insurance engine 126 can specifically identify the homeowners insurance merchant 102a, thereby distinguishing it from other insurance merchants (that may not offer homeowners insurance). In addition, the insurance engine 126 may further be configured to rely on historical transaction data for insurance merchants (per consumer) in the data structure 128, for example, to identify homeowners insurance merchants, as compared to other insurance merchants and/or other insurance products (e.g., based on fluctuations in premiums since premium amounts for homeowners insurance may have smaller variances for a given region may correlate more with location than automobile insurance, etc.). Regardless, once all the homeowners insurance merchants are identified (including insurance merchants 102a and 102b in this example), the insurance engine 126 is configured to define and store a data structure of the identified insurance merchant(s) (e.g., a list, a table, etc.) in the data structure 128.

Next, based on the transaction data in the data structure 128, the insurance engine 126 is configured to determine a subset of transactions for the identified property insurance merchants (e.g., merchants 102a and 102b, etc.). In doing so, the insurance engine 126 may be configured to include all transactions to the identified homeowners insurance merchants in the subset. Then, the insurance engine 126 may filter the transactions to those involving only repeated payments (e.g., transactions involving repeat payments of insurance premiums, transactions involving recurring payments potentially indicating that the insurance premiums are split into multiple payments (e.g., for transactions in which a recurring payment indicator is included in a particular data element, etc.), etc.) over a period of time (e.g., transactions to an identified insurance merchant occurring monthly, biannually, annually, etc.) in the subset, and/or transactions involving products with the term “insurance” in their description, etc. (or, such transactions may be included in a further subset of the initial subset of all transactions for the identified property insurance merchants). In any case, the ultimate subset of transactions for the identified property insurance merchants generally includes transactions for homeowners insurance involving the merchants (e.g., for homeowners insurance products previously sold to consumer 114 in connection with premises 112, etc.). The subset of transactions may then further be organized into a number of groups or clusters, based on demographic factors associated with the transactions and/or the consumers associated with the payment accounts used in the transactions (e.g., consumers 114, etc.). For example, initial subsets of transactions may be compiled as described above for each of different postal codes associated with the insurance merchants. And again, once determined (broadly, once compiled), the insurance engine 126 is configured to store and/or designate the subset of transactions in the data structure 128, for retrieval, as described below.

The insurance engine 126 is also configured to determine particular locations of the premises 112 involved in the transactions included in the subset. To do so, the insurance engine 126 may be configured to rely on address information included in virtual wallets or other network-based applications associated with payment accounts involved in the transactions. Additionally, or alternatively, the insurance engine 126 may be configured to rely on one or more services, and potentially, third party services (e.g., via address verification systems (AVS), etc.), to match the consumers (e.g., consumers 114, etc.) and/or payment accounts involved in the transactions to particular addresses. Further, the insurance engine 126 may be configured to rely on transaction histories for the payment accounts involved in the transactions, within the subset, to identify a general center and/or region of the historical transactions to the particular payment accounts (e.g., taking into account additional or all transactions to the particular payment accounts such as grocery store transactions, etc.), thereby estimating the regions (e.g., by postal codes, cities, etc.) of the consumers' premises (e.g., of each of the premises 112, etc.). The different factors identified above for use in identifying locations of the consumers and/or their premises may be used together, or separately, by the insurance engine 126. What's more, the insurance engine 126 may be configured to rely on additional and/or different factors in other embodiments. In any event, once the locations of premises involved in the transactions are determined, the insurance engine 126 is configured to append, in the data structure 128, the locations to the subset of transactions and/or otherwise designate the transactions with the locations.

Subsequently, or previously, in the exemplary embodiment, the consumer 118 determines that he/she desires and/or needs to purchase one or more insurance products to provide coverage for the premises 116. In response, the consumer 118 interacts with the communication device 124 (e.g., via a network-based application, etc.), which is configured, in turn, to submit a request (in response to one or more inputs from the consumer 118) to the insurance engine 126, requesting the identification of one or more insurance merchant(s) and/or approximate costs for desired insurance products for the premises 116 (e.g., homeowner's insurance in this example, etc.). The request may include, without limitation, a name of the consumer 118, an address of the premises 116, a profile of the premises (e.g., 4 bedrooms, 3 bathrooms, 2000 sq. ft., etc.), and/or may include further details of the consumer 118, the premises 116, and/or the insurance product of interest, etc.

In response, the insurance engine 126 is configured to receive the request and to retrieve the subset of transactions from the data structure 128, for example, relating to homeowners insurance in this example, based on the request, and specifically, based on the location included in the address for the premises 116 (e.g., the particular subset retrieved may be a subset grouped based on a postal code consistent with the address for the premises 116, etc.), and to generate an aggregate insurance indicator specific to the request based on the retrieved subset of transactions. The aggregate insurance indicator may include certain indications related to the desired insurance product(s) included in the request such as, for example, a lowest premium product, an average premium for the desired product(s), and/or the highest premium product, per insurance merchant. The insurance engine 126 is configured to then transmit the aggregate insurance indicator to the consumer 118, at the communication device 124, for his/her review. The aggregate insurance indicator may include links, for example, to the particular insurance merchants associated with the indications, and/or other content relating thereto should the consumer 118 decide to purchase the insurance form one of the insurance merchants. Moreover, a similar aggregate insurance indicator may be generated and transmitted to the identified insurance merchants, whereby the insurance merchants may be able to evaluate and/or adjust premiums in a particular region and/or for particular types of insurance products.

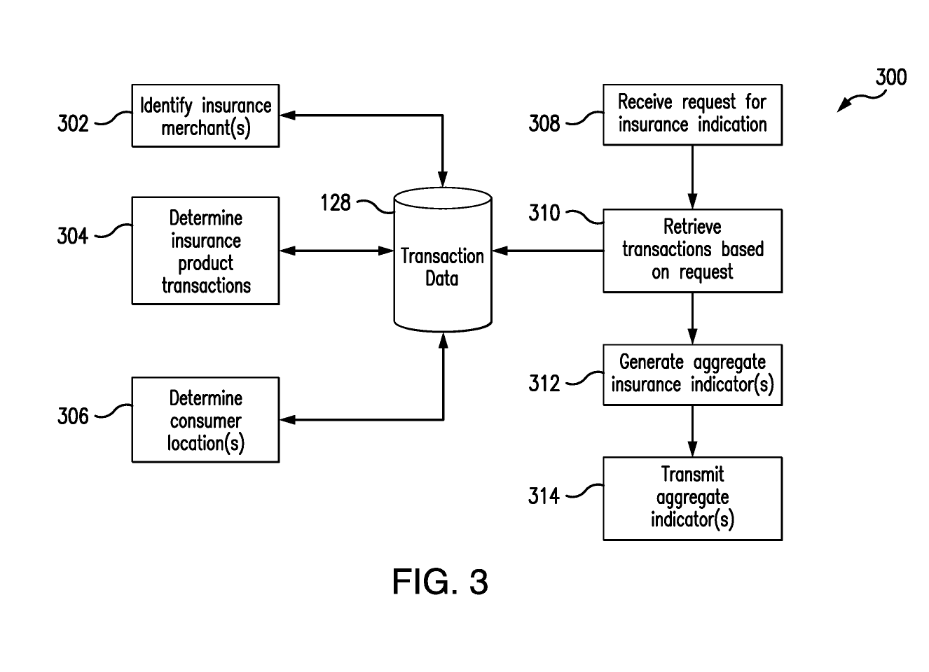

FIG. 3 illustrates an exemplary method 300 for providing indicators related to insurance products. The exemplary method 300 is described as implemented in the insurance engine 126 of the system 100, and further with reference to computing device 200. However, it should be understood that the method 300 is not limited to this configuration/implementation, as the method 300 may be implemented in other parts (or combinations of parts) of the system 100, or in multiple other computing devices. As such, the methods herein should not be understood to be limited to the exemplary system 100 or the exemplary computing device 200, and likewise, the systems and the computing devices herein should not be understood to be limited to the exemplary method 300. In addition, the exemplary method 300 is described in connection with an inquiry by the consumer 118 for homeowners insurance for premises 116. However, it should also be understood that the method 300 is not limited to homeowners insurance products and may be applied to any desired insurance products, as described herein, within the scope of the present disclosure.

As shown in FIG. 3, initially in the method 300 (either prior to the inquiry by the consumer 118 or subsequent thereto), the insurance engine 126 identifies, at 302, one or more particular insurance merchants from the data structure 128 associated with selling homeowners insurance, based on historical transactions involving the merchants. As described above, each of the transactions in the data structure 128 is associated with a merchant name, a merchant ID, a MCC, a transaction amount, and other suitable information.

In connection therewith, the insurance engine 126 first identifies merchants based on whether the merchants are insurers (e.g., based on their names, etc.). This may include searching various publically available records (e.g., websites, etc.) for registered insurance providers, in general or for a particular region (e.g., for a particular state, country, etc.). Or, this may include searching in a proprietary data structure (as part of data structure 128 or separate therefrom), for example, compiled by the payment network 106, etc. and comprising a merchant hierarchy that includes data relating to various merchants involved in transactions processed by the payment network 106, including name, industry classification, etc. In the latter, for example, merchants in the data structure may be assigned particular codes, in connection with the North American Industry Classification System (NAICS), whereby the data structure may be queried for a particular code for property insurance (e.g., 524126, etc.) to thereby identify property insurance merchants. In any case, once the desired insurance merchants are identified, the insurance engine 126 then filters and/or searches in the transaction data in the data structure 128 of the identified merchants for an MCC associated with insurance products (e.g., MCC 6300, etc.). By searching and/or filtering the identified insurance merchants based on name and MCC, for example, the insurance engine 126 is able to eliminate merchants that may offer for sale, and may sell, other insurance of a type not at interest here.

As an example, Table 1 includes transaction data for insurance merchants 102a and 102b, as identified at operation 302 in the method 300, and as may be included in a segment of the data structure 128.

TABLE 1

| | | | | Merchant | | |
|---|---|---|---|---|---|---|
| | Merchant | Name | MCC | ID | Amount | Date |
| #1 | Merchant | ABC | 6300 | 12345-1 | $1,200.23 | 6/3 |
| | 102a | Insurance | | | | |
| #2 | Merchant | XYZ | 6300 | 65432-1 | $403.41 | 6/6 |
| | 102b | Insurance | | | | |
| #3 | Merchant | ABC | 6300 | 12345-2 | $390.42 | 8/8 |
| | 102a | Insurance | | | | |
| #4 | Merchant | XYZ | 6300 | 65432-1 | $850.10 | 9/13 |
| | 102b | Insurance | | | | |
| #5 | Merchant | XYZ | 6300 | 65432-2 | $491.22 | 10/13 |
| | 102b | Insurance | | | | |
| #6 | Merchant | XYZ | 6300 | 65432-1 | $1154.21 | 11/21 |
| | 102b | Insurance | | | | |
| #7 | Merchant | ABC | 6300 | 12345-1 | $905.21 | 11/26 |
| | 102a | Insurance | | | | |
| #8 | Merchant | XYZ | 6300 | 65432-1 | $403.41 | 12/6 |
| | 102b | Insurance | | | | |
| #9 | Merchant | ABC | 6300 | 12345-2 | $455.20 | 12/8 |
| | 102a | Insurance | | | | |
| . . . | . . . | . . . | . . . | | . . . | . . . |

Next, the insurance engine 126 determines, at 304, which of the transactions in the data structure for the identified insurance merchants are insurance transactions for particular insurance products of interest, for example, homeowners insurance products in this example. In particular, the insurance engine 126 may filter the transactions based on merchant IDs for the identified merchants specific to homeowners insurance. Or, the insurance engine 126 may determine which of the transactions are for homeowners insurance based on recurring aspects of the transactions in the data structure 128 (e.g., recurring transactions on an annual basis may be for homeowners insurance, while recurring transactions on a more frequent basis may be for other insurance products, etc.). With regard to Table 1, for example, taking into account merchant IDs for the insurance merchants 102a and 102, the insurance engine 126 may identify transactions #1, #2, #4, #6, #7, and #8 as involving homeowners insurance (based on the merchant ID 12345-1 for the merchant 102a being associated with homeowners insurance, and the merchant ID 65432-1 for the merchant 102b being associated with homeowners insurance).

Then in the method 300, the insurance engine 126 determines, at 306, locations of the consumers (e.g., consumers 114, etc.) associated with each of the transactions determined to be for the insurance products of interest, i.e., homeowners insurance in this example. In general, the insurance engine 126 may determine the locations of the transactions based on address information assigned to one or more network-based applications associated with payment accounts involved in the transactions. Additionally, or alternatively, the insurance engine 126 may determine the locations based on one or more services, which match the consumers and/or payment accounts involved in the transactions to particular addresses. Further, the insurance engine 126 may determine the locations of the transactions based on transaction histories for the payment accounts. In the latter, for example, merchants included in the transaction data for a particular payment account may be identified and used to determine a center of the transactions for the payment account, which will likely be a region in which the consumer lives thereby providing an estimate of the location of the consumer associated with the payment account (and his/her premises). In particular in this example, a center of grocery store transactions for the payment account may be used to estimate the location of the consumer, where the grocery store transactions are identified in the transaction data based on card present transactions and MCC 5411, and where locations (e.g., GPS coordinates, etc.) of the corresponding merchants for the grocery store transactions may then be identified in the data structure described above compiled by the payment network 106 and comprising a merchant hierarchy that includes data relating to various merchants involved in transactions processed by the payment network 106. Once determined, as shown in Table 2, the locations are appended to the homeowners insurance transactions (and, potentially, appended to the corresponding payment accounts).

TABLE 2

| | | | | Merchant | | Consumer | |
|---|---|---|---|---|---|---|---|
| | Merchant | Name | MCC | ID | Amount | Location | Date |
| #1 | Merchant | ABC | 6300 | 12345-1 | $1,200.23 | Region #1 | 6/3 |
| | 102a | Insur- | | | | | |
| | | ance | | | | | |
| #2 | Merchant | XYZ | 6300 | 65432-1 | $403.41 | Region #2 | 6/6 |
| | 102b | Insur- | | | | | |
| | | ance | | | | | |
| #4 | Merchant | XYZ | 6300 | 65432-1 | $850.10 | Region #2 | 9/13 |
| | 102b | Insur- | | | | | |
| | | ance | | | | | |
| #6 | Merchant | XYZ | 6300 | 65432-1 | $1154.21 | Region #2 | 11/21 |
| | 102b | Insur- | | | | | |
| | | ance | | | | | |
| #7 | Merchant | ABC | 6300 | 12345-1 | $905.21 | Region #2 | 11/26 |
| | 102a | Insur- | | | | | |
| | | ance | | | | | |
| #8 | Merchant | XYZ | 6300 | 65432-1 | $403.41 | Region #2 | 12/6 |
| | 102b | Insur- | | | | | |
| | | ance | | | | | |
| . . . | . . . | . . . | . . . | | . . . | . . . | . . . |

In this exemplary embodiment, after the above, the consumer 118 submits a request for an indication of an insurance product related to the premises 116 in Region #2 (i.e., homeowners insurance in this example), via the communication device 124, for example, to the insurance engine 126. In turn, at 308, the insurance engine 126 receives the consumer's request. The request includes, in this embodiment, the address of the premises 116 to be insured (indicating the location of the premises in Region #2), and potentially, the name of the consumer 118, and the profile of the premises 116, etc.

In response, the insurance engine 126 retrieves transaction data, at 310, from the data structure 128, and in particular, transaction data involving transactions for the particular type of insurance product identified by the consumer 118 in request, i.e., homeowners insurance in this example. In doing so, the insurance engine 126 employs the address and/or location of the premises 116 to retrieve the appropriate subset of transaction data. As such, with reference to FIG. 1, the transaction data retrieved will be limited to transaction data involving transactions in Region #2 (in which the premises 116 is located). With reference to Table 2, and the appended locations from above, for example, transactions #2, #4, #6, #7, and #8 are retrieved as being with Region #2. To the extent that the request includes a profile for the premises 116, the insurance engine 126 may further retrieve (or filter), for example, transactions in which the involved premises has a certain number of bedrooms, bathrooms, etc. consistent with the profile for the premises 116

Regardless, once the appropriate transaction data is retrieved, the insurance engine 126 generates, at 312, one or more aggregate insurance indicators for the consumer 118. In so doing, the insurance engine 126 initially normalizes the transaction amounts for each of the transactions in the transaction data to a common term/period (e.g., to annual payments, etc.). For example, the insurance engine 126 may evaluate the transactions to determine whether any involve recurring payments, potentially indicating that the insurance premiums are split into multiple payments over the common term (e.g., for transactions in which a recurring payment indicator is included in a particular data element, etc.). The identified recurring payments are then normalized to the common term, and the insurance engine 126 determines the desired aggregate insurance indicator(s).

In connection with the above example shown in Tables 1 and 2, the insurance engine 126 may use the data to generate an average premium indicator for the consumer 118, for homeowners insurance in Region #2, as well as a highest premium and a lowest premium as additional insurance indicators. In so doing, the insurance engine 126 initially normalizes the transaction amounts in Table 2, for transactions #2, #4, #6, #7, and #8, to annual payments. This includes summing the payments for the recurring transactions #2 and #8, and then using the resulting sum in combination with the payments in transactions #4, #6, and #7 to provide the average premium indicator. As such, in this example, the insurance engine 126 determines that an average premium for homeowners insurance in Region 2 is about $929.09. In addition in this example, the insurance engine 126 may identify the highest premium insurance indicator as $1154.21 (associated with merchant 102b), and the lowest premium insurance indicator as $806.81 (also associated with merchant 102b).

The insurance engine 126 then transmits, at 314, the aggregate indicators to the consumer 118, thereby responding to the request. The aggregate indicators may be included in a report or other form, in which the insurance engine 126 may further include a link or web address for one or more of the insurance merchants associated with the indicators, such as, for example, the insurance merchant 102b. In addition to use by the consumer 118, the insurance merchants 102a and 102b may request similar insurance indicators. For example, the insurance merchant 102a may request high, low, and average premiums from the region A in FIG. 1, to determine why sales of insurance products are high or low, or to determine how its premium rate compares against the average, for example. The insurance merchants may then adjust premiums, enter an insurance market, or leave an insurance market based on the insurance indicators and/or business decisions based, at least in part, thereon.

It should be appreciated that while operations 302 to 306 are performed prior to receiving the consumer's (or merchant's) request in the above description, the order may be reversed in other embodiments. Instead, for example, the insurance merchants, the insurance transactions and the consumer locations may be identified/determined after receipt of a request and/or potentially based on the request. As such, rather than compiling a transaction set for each region, the insurance engine 126 may only identify insurance merchants in one region, and transactions in one region (for one specific insurance product), and for consumers in one region.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by: (a) receiving, from a requestor, a request for an insurance indicator associated with an insurance product of interest in a region; (b) retrieving, by a computing device, a plurality of transactions, each transaction involving a purchase of the issuance product of interest and being associated with the region; (c) aggregating, by the computing device, the plurality of transactions to define the insurance indicator, the insurance indicator indicative of at least one premium for the insurance product of interest; and (d) transmitting the insurance indicator to the requestor, such that the requestor is informed about cost of the insurance product of interest in the region.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for determining at least one insurance indicator related to an insurance product of interest based on transaction data for various merchants, the method comprising:
receiving, from a requestor, a request for an insurance indicator associated with an insurance product of interest in a region;
retrieving, by a computing device, a plurality of transactions, each transaction involving a purchase of the issuance product of interest and being associated with the region;
aggregating, by the computing device, the plurality of transactions to define the insurance indicator, the insurance indicator indicative of at least one premium for the insurance product of interest; and
transmitting the insurance indicator to the requestor, such that the requestor is informed about cost of the insurance product of interest in the region.

2. The computer-implemented method of claim 1, wherein the insurance indicator includes at least two of a highest insurance premium, a lowest insurance premium, and an average insurance premium.

3. The computer-implemented method of claim 1, further comprising determining that each of the plurality of transactions involves the purchase of the insurance product of interest based on a merchant category code (MCC) associated with the transaction and a recurring aspect of the transaction, prior to retrieving the plurality of transactions.

4. The computer-implemented method of claim 1, further comprising determining the plurality of transactions based on a merchant category code (MCC) of a merchant involved in each of the plurality of transactions and/or a merchant identifier of a merchant involved in each of the plurality of transactions, prior to retrieving the plurality of transactions.

5. The computer-implemented method of claim 4, further comprising determining a location of a consumer associated with each of the plurality of transactions and appending the location to the plurality of transactions; and
wherein retrieving the plurality of transactions includes retrieving the plurality of transactions based on the appended location for each of the plurality of transactions being within the region.

6. The computer-implemented method of claim 5, wherein retrieving the plurality of transactions further includes retrieving the plurality of transactions based on a profile of a premises associated with the consumer and to which the insurance product of interest is directed.

7. The computer-implemented method of claim 1, further comprising identifying, at the computing device, a merchant as being an insurance merchant for the insurance product of interest; and
determining the plurality of transactions based on at least the identified insurance merchant.

8. The computer-implemented method of claim 7, wherein determining the plurality of transactions is further based on a location associated with each of the plurality of transactions being within the region.

9. The computer-implemented method of claim 8, wherein the requestor includes a consumer;
wherein a premises associated with the consumer is within the region; and
wherein the insurance product of interest is a homeowners insurance product.

10. A system for determining at least one insurance indicator related to an insurance product of interest based on transaction data for various merchants, the system comprising:
a memory comprising a data structure having transaction data for transactions involving multiple insurance merchants; and
a processor coupled to the memory and configured to:
retrieve a plurality of transactions from the transaction data in the data structure in response to a request from a requestor for an insurance indicator associated with an insurance product of interest in a region, each transaction involving a purchase of the insurance product of interest;
aggregate the plurality of transactions and generate the insurance indicator, the insurance indicator indicative of at least one premium for the insurance product of interest; and
transmit the insurance indicator to the requestor, such that the requestor is informed about cost of the insurance product of interest.

11. The system of claim 10, wherein the processor is further configured to determine the plurality of transactions based on a merchant category code (MCC) of a merchant involved in each of the plurality of transactions and/or a merchant identifier of a merchant involved in each of the plurality of transactions, prior to retrieving the plurality of transactions.

12. The system of claim 11, wherein the processor is further configured to determine a location of a consumer associated with each of the plurality of transactions and append the location to the plurality of transactions.

13. The system of claim 12, wherein the processor is configured, in connection with retrieving the plurality of transactions, to retrieve the plurality of transactions further based on a profile of a premises associated with the consumer and to which the insurance product of interest is directed.

14. The system of claim 12, wherein the processor is configured, in connection with retrieving the plurality of transactions, to retrieve the plurality of transactions based on the appended consumer location for each of the plurality of transactions being within the region.

15. The system of claim 14, wherein the insurance indicator includes at least two of a highest insurance premium, a lowest insurance premium, and an average insurance premium.

16. The system of claim 11, wherein the processor is configured, in connection with determining the plurality of transactions, to determine the plurality of transactions further based on a recurring aspect of the transaction, prior to retrieving the plurality of transactions.

17. A non-transitory computer-readable storage media including computer-executable instructions for determining at least one insurance indicator related to an insurance product of interest based on transaction data for various merchants, which, when executed by a processor, cause the processor to:
receive, from a requestor, a request for an insurance indicator associated with an insurance product of interest in a region;
in response to the request, determine a plurality of transactions based on a merchant category code (MCC) of a merchant involved in each of the plurality of transactions and/or a merchant identifier of a merchant involved in each of the plurality of transactions, prior to retrieving the plurality of transactions, each of the plurality of transactions involving a purchase of the insurance product of interest and being associated with the region;
aggregate the plurality of transactions and generate the insurance indicator based on the aggregated transactions, the insurance indicator indicative of a cost for the insurance product of interest; and
transmit the insurance indicator to the requestor, such that the requestor is informed about the cost of the insurance product of interest in the region.

18. The non-transitory computer-readable storage media of claim 17, wherein the computer-executable instructions, when executed by the processor, further cause the processor to determine a location of a consumer associated with each of the plurality of transactions and append the location to the corresponding transaction in the plurality of transactions.

19. The non-transitory computer-readable storage media of claim 18, wherein the computer-executable instructions, when executed by the processor, further cause the processor to transmit the insurance indicator to at least one merchant involved in each of the plurality of transactions.

20. The non-transitory computer-readable storage media of claim 18, wherein the computer-executable instructions, when executed by the processor, further cause the processor, in connection with determining the plurality of transactions, to determine the plurality of transactions based on the appended consumer location for each of the plurality of transactions being within the region.
